(19) United States
(12) Patent Application Publication
(10) Pub. No.: US 2013/0212538 A1
(43) Pub. Date: Aug. 15, 2013

(54) IMAGE-BASED 3D ENVIRONMENT EMULATOR

(71) Applicants: Ghislain LEMIRE, Sainte-Julie (CA); Martin LEMIRE, St-Charles Borromee (CA)

(72) Inventors: Ghislain LEMIRE, Sainte-Julie (CA); Martin LEMIRE, St-Charles Borromee (CA)

(21) Appl. No.: 13/589,638

(22) Filed: Aug. 20, 2012

Related U.S. Application Data
(60) Provisional application No. 61/525,354, filed on Aug. 19, 2011.

(51) Int. Cl. G06F 3/0481

(52) U.S. Cl. CPC G06F 3/04815
USPC 715/850

(57) ABSTRACT

An image-based 3D environment emulator incorporates a 3D engine. The background or decor of the 3D environment is created using a series of 2D images, and 3D objects are rendered by the 3D engine. The 2D image displayed on a 2D plane and the 3D objects are projected onto the same plane. The 2D image is visible behind the 3D objects and appears blended therewith. A 3D illusion is created and the user can interact with the 3D objects as he navigates throughout the environment. Navigation from image to image is calculated in real time. A viewing position of the 3D objects inside a 3D space created by the 3D engine is updated to reflect a new viewing position and/or viewing angle in accordance with navigation instructions received from a user. A new 2D image is provided and the projection of the 3D objects is updated accordingly.

### CROSS-REFERENCE TO RELATED APPLICATIONS

This application claims priority under 35 U.S.C. 119(e) of Provisional Patent Application No. 61/525,354 filed on Aug. 19, 2011, the contents of which are hereby incorporated by reference.

### TECHNICAL FIELD

The present invention relates to the field of immersive virtual 3D environments and more particularly, to image-based immersive environments.

### BACKGROUND OF THE ART

A trend recently observed in the IT industry is that of “gamification”. Gamification is the use of game play elements for non-game applications, particularly consumer-oriented web and mobile sites, in order to encourage people to adopt the applications. It also strives to encourage users to engage in desired behaviors in connection with the applications. Gamification works by making technology more engaging, and by encouraging desired behaviors, taking advantage of psychological predispositions to engage in gaming. One way to “gamify” a consumer-oriented web site is to create an immersive 3D virtual environment in which a user can navigate, and to incorporate gaming elements therein.

Immersive 3D virtual environments refer to any form of computer-based simulated 3D environment through which users can interact, either with one another or with objects present in the virtual world, as if they were fully immersed in the environment. Video games are often provided within immersive 3D environments.

Most 3D virtual environments for video games are created with a 3D rendering engine. Rendering is the 3D computer graphics process of automatically converting 3D models into 2D images with 3D photorealistic effects on a computer. The process of rendering may take from fractions of a second to days for a single image/frame. However, when creating a 3D virtual environment for a game, the most time consuming step of the process is that of designing the 3D model for the rendering. It can take graphic artists weeks or months before completing a single game décor. While time consuming, this technique allows a high level of detail and a very realistic effect.

An alternative to using a 3D rendering engine is generating 3D environments that are image-based. A plurality of images are taken from different perspectives using a camera and the images are stitched together or positioned in a 3D environment to provide an illusion of 3D, without actually being based on 3D models. This technique is far less time consuming, but is limited in its ability to provide a true dynamic environment. The images are static and while the user can navigate in the environment, there is no interaction comparable to what a video game can provide.

The polygon-based 3D rendering techniques and the image-based simulated environments do not lend themselves easily to the desire to gamify a website or other virtual environment, in view of the respective challenges presented.

### SUMMARY

There is described herein an image-based 3D environment emulator that incorporates a 3D engine. The background or decor of the 3D environment is created using a series of 2D images, and 3D objects are rendered by the 3D engine. The 2D image displayed on a 2D plane and the 3D objects are projected onto the same plane. The 2D image is visible behind the 3D objects and appears blended therewith. A 3D illusion is created and the user can interact with the 3D objects as he navigates throughout the environment. Navigation from image to image is calculated in real time. A viewing position of the 3D objects inside a 3D space created by the 3D engine is updated to reflect a new viewing position and/or viewing angle in accordance with navigation instructions received from a user. A new 2D image is provided and the projection of the 3D objects is updated accordingly.

In accordance with a first broad aspect, there is provided an apparatus for providing a virtual 3D environment comprising a storage medium for storing at least one 3D object and at least one 2D image from a plurality of sets of 2D images, each set of 2D images corresponding to a substantially 360° view at a given position in a 3D space, each 2D image in the set of 2D images corresponding to a view at a viewing angle at the given position in the 3D space. The apparatus also comprises a 3D engine for creating the 3D space and displaying the at least one 3D object in the 3D space; and a control center connected to the storage medium and the 3D engine. The control center is adapted for: loading a 2D image from a selected one of the plurality of sets of 2D images and projecting a camera view of the 3D engine onto the 2D image such that the 2D image and the at least one 3D object are blended together to form an initial view in the virtual 3D environment; receiving navigation instructions; determining in real time a new 2D image corresponding to a desired viewing position and a desired viewing angle in accordance with the navigation instructions; determining if the at least one 3D object requires modification and instructing the 3D engine accordingly; and loading the new 2D image such that the new 2D image and the at least one 3D object are blended together to form a subsequent view in the virtual 3D environment.

In accordance with a second broad aspect, there is provided a method for providing a virtual 3D environment, the method comprising: storing a plurality of 3D objects and a plurality of sets of 2D images, each set of 2D images corresponding to a substantially 360° view at a given position in a 3D space, each 2D image in the set of 2D images corresponding to a view at a viewing angle at the given position in the 3D space; creating the 3D space with a 3D engine and displaying the 3D objects in the 3D space; loading a 2D image from a selected one of the plurality of sets of 2D images and projecting a camera view of the 3D engine onto the 2D image such that the 2D image and the 3D objects are blended together to form an initial view in the virtual 3D environment; receiving navigation instructions; determining in real time a new 2D image corresponding to a desired viewing position and a desired viewing angle in accordance with the navigation instructions; determining if the 3D objects require modification and instructing the 3D engine accordingly; and loading the new 2D image such that the new 2D image and the 3D objects are blended together to form a subsequent view in the virtual 3D environment.

In accordance with another broad aspect, there is provided a computer readable medium having stored thereon computer executable code for providing a virtual 3D environment, the computer executable code comprising instructions for accessing a storage medium comprising a plurality of 3D objects and at least one 2D image from a plurality of sets of 2D images, each set of 2D images corresponding to a substantially 360° view at a given position in a 3D space, each 2D image in the set of 2D images corresponding to a view at a viewing angle at the given position in the 3D space; creating the 3D space with a 3D engine and displaying the 3D objects in the 3D space; loading a 2D image and projecting a camera view of the 3D engine onto the 2D image such that the 2D image and the 3D objects are blended together to form an initial view in the virtual 3D environment; receiving navigation instructions; determining in real time a new 2D image corresponding to a desired viewing position and a desired viewing angle in accordance with the navigation instructions; determining if the 3D objects require modification and instructing the 3D engine accordingly; and loading the new 2D image such that the new 2D image and the 3D objects are blended together to form a subsequent view in the virtual 3D environment.

In this specification, the term “objects” is intended to refer to any element making up a website or the 3D environment and should not be interpreted as meaning that object-oriented code is used.

### BRIEF DESCRIPTION OF THE DRAWINGS

Further features and advantages of the present invention will become apparent from the following detailed description, taken in combination with the appended drawings, in which:

FIG. 1 is a schematic diagram of an exemplary system for providing an immersive 3D virtual environment;

FIG. 2 is a traditional spatial representation of a set of positions in a 3D space;

FIG. 3 is an exemplary reduced spatial representation of a set of positions in a 3D space;

FIG. 4 is a block diagram of an exemplary image-based 3D emulator from FIG. 1;

FIG. 5 is a schematic representation of an exemplary application running on the image-based 3D emulator of FIG. 4;

FIG. 6a is a perspective view of the 3D space as created by a 3D engine;

FIG. 6b is a top view of the blended camera view from the 3D space and 2D image;

FIG. 7 is a screenshot of an exemplary view as provided by the image-based 3D emulator;

FIG. 8 is a flowchart of an exemplary start routine for the application of FIG. 5;

FIG. 9 is a flowchart of an exemplary initialization process for a 3D engine;

FIG. 10 is a flowchart of an exemplary initialization process for a photo loader;

FIG. 11 is a flowchart of an exemplary method for jumping from one set of panoramas to another set of panoramas;

FIG. 12 is a flowchart of an exemplary method for navigating from one panorama to another panorama; and

FIG. 13 is a block diagram of an exemplary embodiment of the control center of FIG. 5.

It will be noted that throughout the appended drawings, like features are identified by like reference numerals.

### DETAILED DESCRIPTION

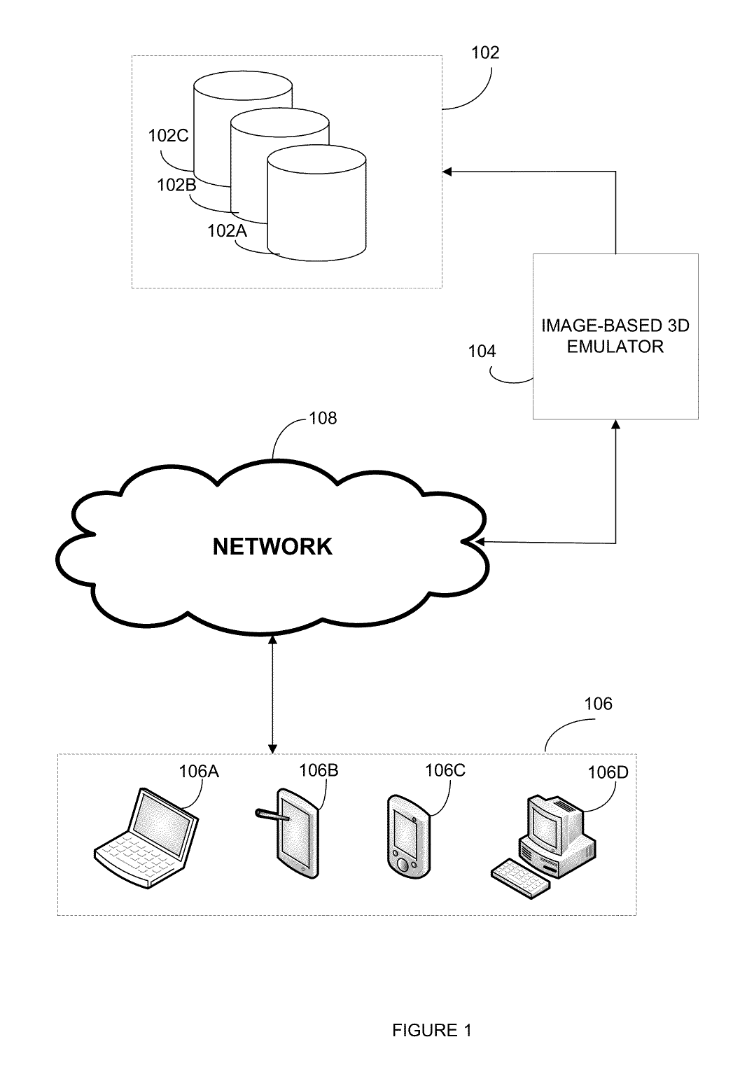

The system described herein is adapted for providing an immersive 3D virtual environment for gamification. A background or decor of the 3D environment is created using a series of 2D images and one or more gaming elements are rendered by a 3D engine. The 2D images and the gaming elements are combined together by an image-based 3D emulator to produce the immersive 3D virtual environment. Referring to FIG. 1, there is illustrated a block diagram of an exemplary embodiment of the system for providing an immersive 3D virtual environment for gamification. One or more databases 102a, 102b, 102c (collectively referred to as 102) contain the set of 2D images. In one embodiment, one database 102a may contain images related to an entire given 3D virtual environment, while in an alternative embodiment, one database 102a may contain information related to only a portion of a given 3D virtual environment, such as one room from a multi-room environment.

The 2D images may be either photographs or rendered 2D views. A plurality of 2D images covering 360° views from a plurality of positions within the environment are provided. The images are organized into subsets to create panoramas. Each panorama represents a 360° view from a given vantage point in the environment and each image in a panorama represents a fraction of the 360° view. For example, if 24 pictures are used per panorama, each image represents approximately 15° of the view. When using photographs, each set of images are acquired using a camera that is rotated about a vertical axis at a given position. All pictures used for a given 3D environment should be shot in a similar manner, namely same first orientation and moving in a clockwise direction. The camera is moved a predetermined distance, such as a few inches, a foot, two feet, etc, and another set of images are taken for a second panorama. The 2D images are stored in the databases 102 with information such as an image ID, an (x, y, z) coordinate, a camera angle, and a camera inclination, to allow them to be identified properly with respect to a 3D space. The same procedure may be used with rendered views, whereby one might imagine a virtual camera is rotated about a vertical axis to acquire the views.

Also present in the databases 102 are gaming elements to be incorporated into the 3D virtual environment. The gaming elements may be composed of 2D objects and/or 3D objects. Examples of 2D objects are dialog boxes and content boxes. The 2D objects may be defined by data structures. They may be global to the entire 3D content (i.e. displayed on every image) or local to given images (i.e. displayed only on selected images). The 2D objects may be incorporated into the 2D image as per the description of U.S. Provisional Patent No. 61/430,618, the contents of which are hereby incorporated by reference.

Examples of 3D objects are markers, arrows, and animations. The 3D objects may be fixed in the 3D environment for each image (such as arrows) or they may be mobile (such as animated ghosts that float around the 3D environment). It should be noted that other 2D/3D objects may be provided in the 3D environment that are not related to gaming. In one embodiment, a global 2D object text box is present on every image and when selected, the gaming elements are added to the 3D environment. The 2D/3D objects, whether related to gaming or not, may be stored in the databases 102.

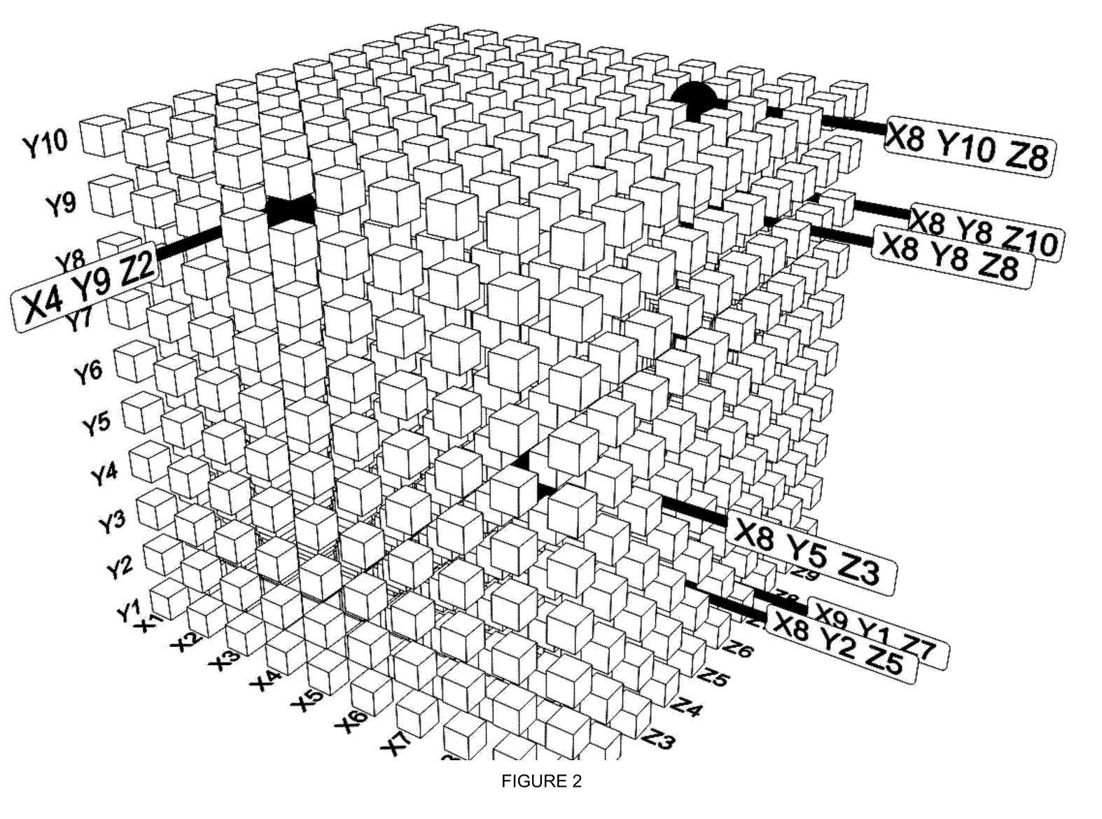

As illustrated in FIG. 1, an image-based 3D emulator 104 accesses the databases 102 to retrieve the 2D images and/or the 2D/3D objects. When the images are loaded into the image-based 3D emulator 104, they may be arranged in a traditional manner, such as that illustrated in FIG. 2. FIG. 2 is a traditional representation of a 3D space, whereby each discrete position in the space corresponds to a point along an x axis, a y axis, and a z axis. When the images are taken, each set of images is taken from a discrete position of the 3D space. When arranging the images in the 3D space, they may be positioned in accordance with their (x, y, z) coordinate in the 3D space and separated from each other using a true representation of the physical distance from which they were taken.

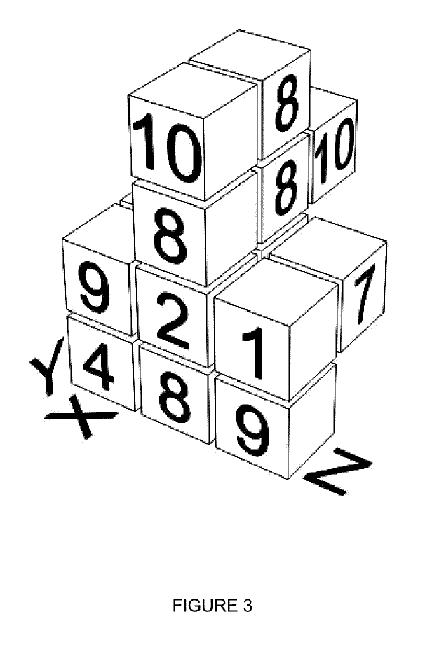

In an alternative embodiment, the images are stored in the image-based 3D emulator 104 in accordance with an optimized spatial representation, as illustrated in FIG. 3. This spatial representation reduces memory space and allows a faster determination of which image to jump to next. As illustrated, the images are sorted by axis and are arranged relative to each other without empty positions between them. That is to say, any position in the 3D spatial representation of FIG. 2 at which no image was taken is removed from the set of points and the remaining set of points (which all represent positions at which images were taken) are arranged relatively to each other without spacing therebetween.

Referring back to FIG. 1, the image-based 3D emulator 104 is accessed by a communication medium 106 such as a laptop 106a, a tablet 106b, a mobile device 106c, a computer 106d, etc, via any type of network 108, such as the Internet, the Public Switch Telephone Network (PSTN), a cellular network, or others known to those skilled in the art. The image-based 3D emulator 104 receives requests from the communication medium 106, and based on those requests, it accesses the databases 102 to retrieve images and provide an immersive 3D virtual environment to the user via the communication medium 106.

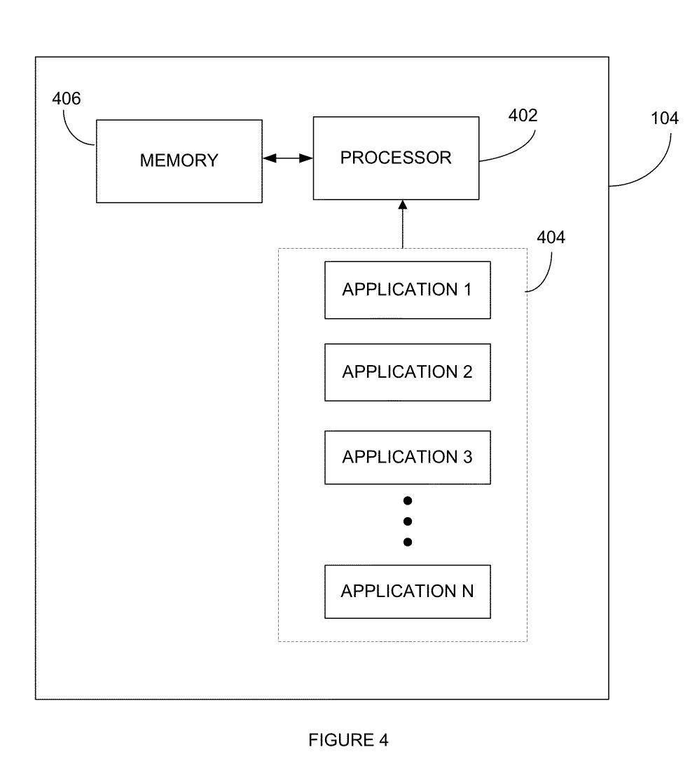

FIG. 4 illustrates the image-based 3D emulator 104 of FIG. 1 as a plurality of applications 404 running on a processor 402, the processor being coupled to a memory 406. It should be understood that while the applications presented herein are illustrated and described as separate entities, they may be combined or separated in a variety of ways. The databases 102 may be integrated directly into memory 406 or may be provided separately therefrom and remotely from the image-based 3D emulator 104. In the case of a remote access to the databases 102, access may occur via any type of network 108, as indicated above. In one embodiment, the databases 102 are secure web servers and Hypertext Transport Protocol Secure (HTTPS) capable of supported Transport Layer Security (TLS) is the protocol used for access to the data. Communications to and from the secure web servers may be secured using Secure Sockets Layer (SSL). An SSL session may be started by sending a request to the Web server with an HTTPS prefix in the URL, which causes port number 443 to be placed into packets. Port 443 is the number assigned to the SSL application on the server.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The memory 406 receives and stores data. The memory 406 may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc.

The processor 402 may access the memory 406 to retrieve data. The processor 402 may be any device that can perform operations on data. Examples are a central processing unit (CPU), a front-end processor, a microprocessor, a graphics processing unit (GPU/VPU), a physics processing unit (PPU), a digital signal processor, and a network processor. The applications 404 are coupled to the processor 402 and configured to perform various tasks as explained below in more detail.

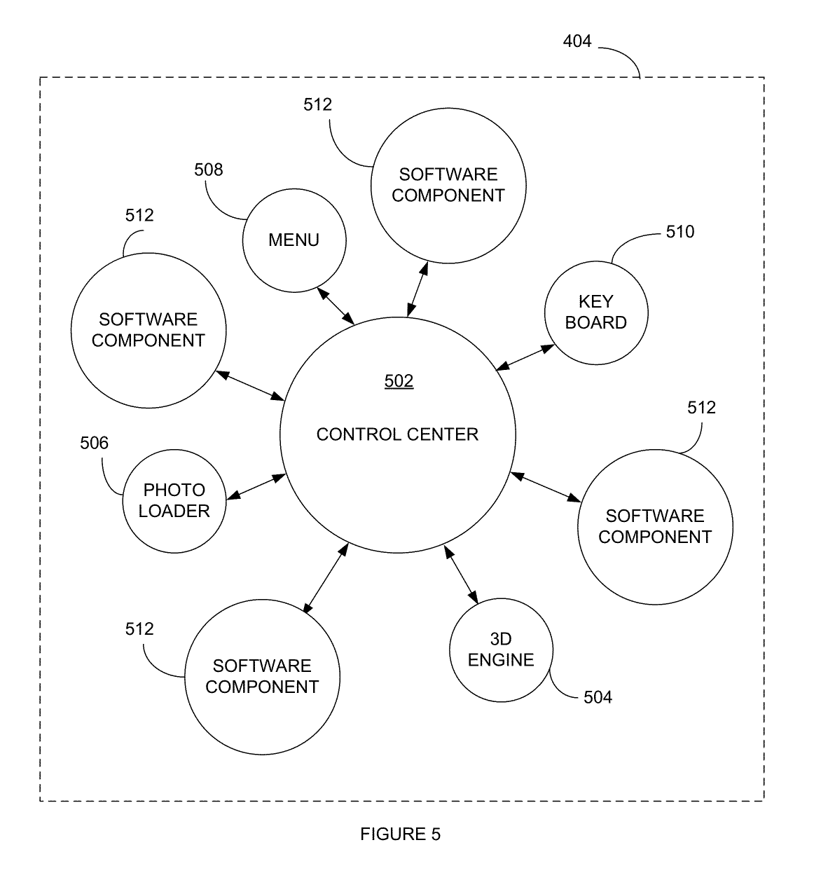

FIG. 5 is an exemplary embodiment of an application 404 running on the processor 402. A control center 502 acts as the core of the application 404 and interacts with a plurality of software components 512 that are used to perform specific functionalities or add specific abilities to the application 404. The software components 512 may be provided as independent components and/or as groups of two or more dependent components. The software components 512 are essentially add-ons that may be implemented as plug-ins, extensions, snap-ins, or themes using known technologies such as Adobe Flash Player™, QuickTime™ and Microsoft Silverlight™. The software components 512 enable customizing of the functionalities of the application 404. Some examples of software components 512 are illustrated in FIG. 5, such as a 3D engine 504, a photo loader 506, a menu module 508, and a key board 510.

Each software component 512 may have its own code for the functions it controls and the code may be compiled directly in the software component 512. The software components 512 are loaded into the application 404 and initialized either sequentially or in parallel. Once all software components 512 have been loaded and initialized, they are then able to communicate with the control center 502.

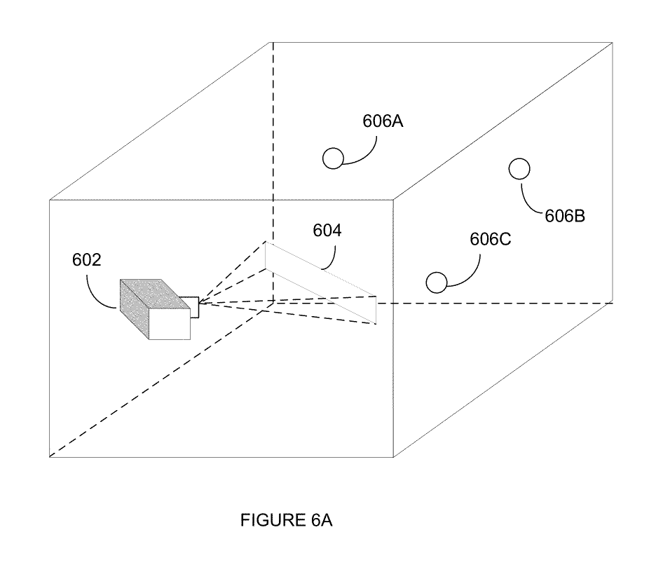

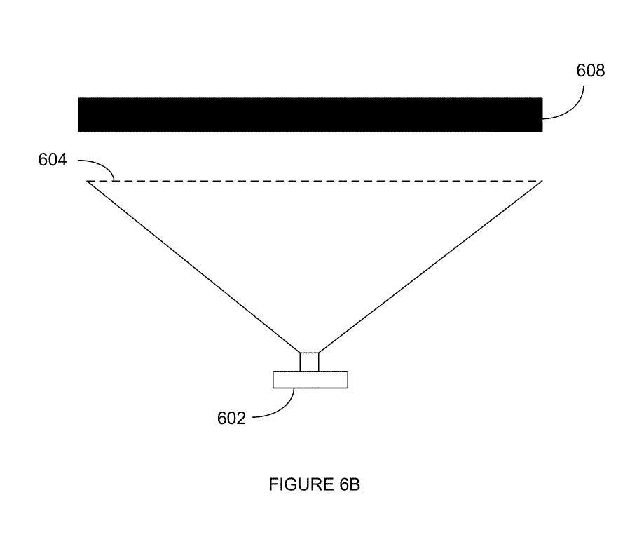

The 3D engine 504 is an exemplary software component that creates and manages a 3D space. The 3D engine 504 may be composed of any known 3D engine, such as Away3D™ or Papervision3D™, that is then adapted to communicate with the control center 502 using a given communication protocol. The 3D engine 504 displays 3D objects in a 3D space as discrete graphical elements with no background. FIG. 6a is a perspective view of the 3D space created by the 3D engine 504. Camera 602 is a virtual camera through which the 3D space is viewed. It is positioned at a coordinate (x, y, z) in the 3D space. 3D objects 606A, 606B, 606C are loaded into the 3D engine 504 and they are displayed by the 3D engine at the appropriate (x, y, z) coordinate in the 3D space.

FIG. 6b is a top view of the 2D image 608 blended with a camera view 604 from the 3D space. The camera view 604 is projected onto a 2D plane outside of the 3D engine 504 that comprises the 2D image 608. The 3D objects 606 are provided as a projection on top of the 2D image 608. Since the camera view 604 contains only the discrete graphical elements and no background, the 2D image 608 forming the background decor is visible behind the 3D objects 606, which appear overlaid directly on top of the 2D image 608.

The photo loader 506 is an exemplary software component used to manage the loading and display of the 2D images 604. The 3D engine 504 and photo loader 506 communicate together through the control center 502 in order to coordinate the display of the 2D images 604 as a function of user navigation in the virtual 3D environment. The menu module 508 is an exemplary software component used to manage a menu available to the user. Similarly, the keyboard module 510 is an exemplary software component used to manage instructions received by the user via the keyboard. It will be understood that software components may be used to manage as many functionalities as desired, and that each software component may be allocated to one or more functionality.

Referring back to FIG. 5, the control center 502 comprises one or more Application Programming Interface (API) for communicating internally and/or with the software components 512. For example, an API may be used to manage (i.e. add, remove, communicate with) software components 512, manage application configuration, manage images, manage events, etc.

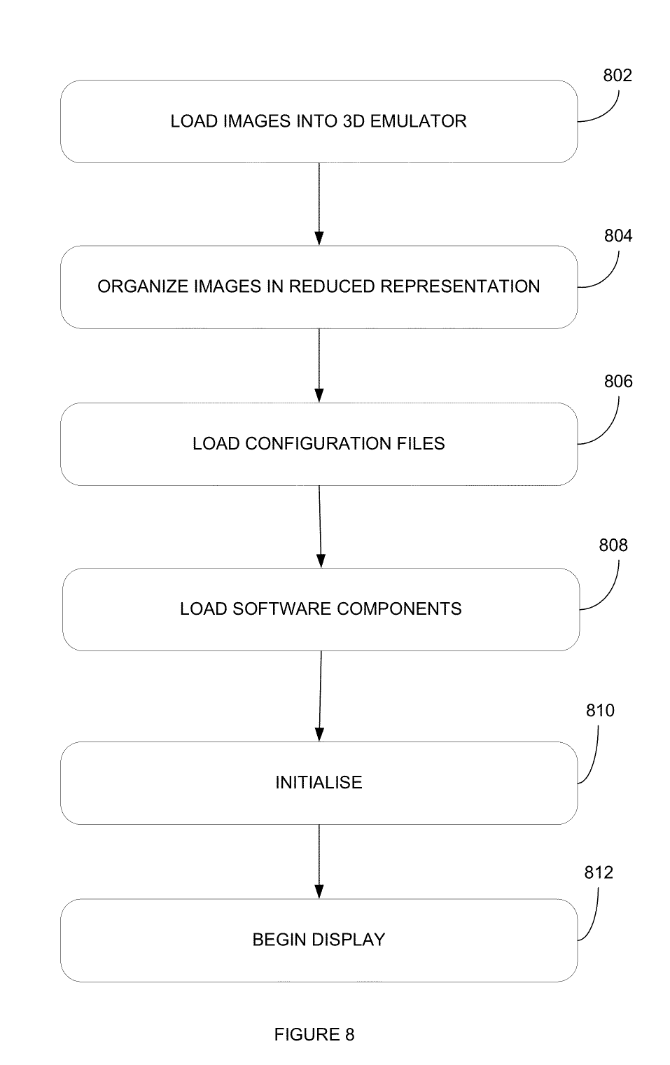

FIG. 8 is a flowchart illustrating an exemplary start routine for the application 104. Steps 802, 804, 806, and 808 are configuration steps and may be performed in an order different than that illustrated. In step 802, the images are loaded from the databases 102 to the memory 406 of the application 104 by the control center 502. In step 804, the images are organized as per a given spatial representation, such as those illustrated in FIGS. 2 and 3. In step 806, various configuration files are loaded, such as those needed for 2D objects and for 3D objects that will be incorporated into the 3D environment. In step 808, the various software components 512 are loaded by the control center 502. Configuration data and customization parameters may be provided as executable flash files in a format such as swf, exe, ipa, etc. Step 810 is an initialization step. Each software component 512 may require its own initialization. After initialization, the application 104 is ready to begin displaying the 3D environment with the gaming elements.

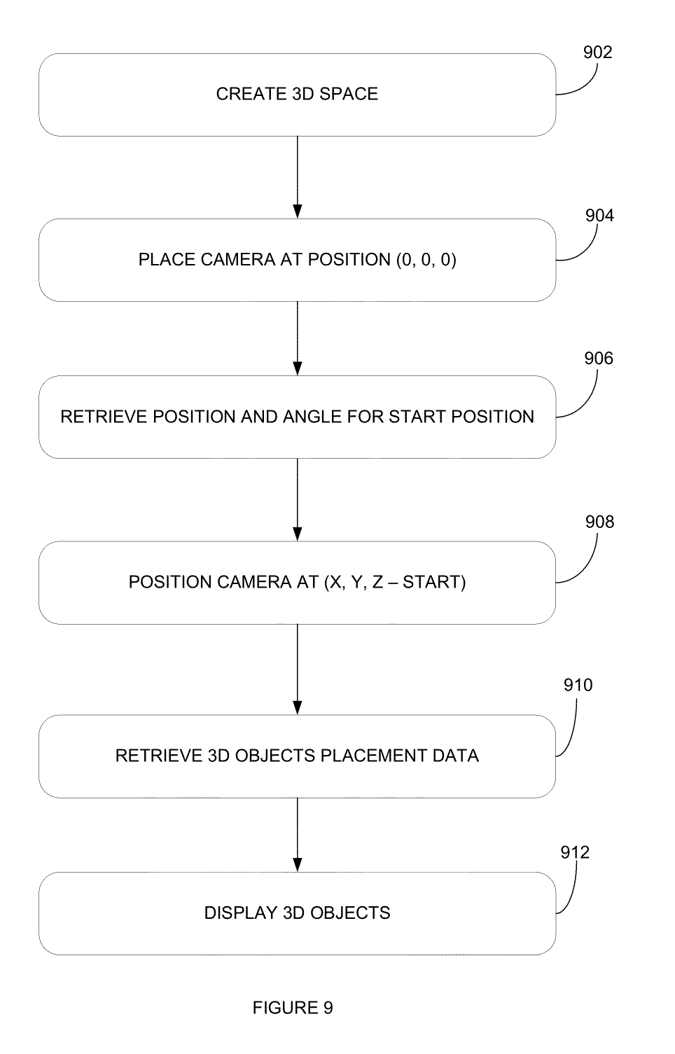

FIG. 9 is a flowchart illustrating an exemplary initialization of the 3D engine 504. In a first step, the 3D space (as illustrated in FIG. 6) is created 702. A camera 602 is placed at coordinate (0, 0, 0) at the time of initialization 704. The 3D engine 504 retrieves a start position 706 for the camera 602, the start position comprising a coordinate (xₛₜₐᵣₜ, yₛₜₐᵣₜ, zₛₜₐᵣₜ) and an angle for the camera 602. The camera 602 is then positioned in accordance with the retrieved start position 708. The 3D engine 504 retrieves data for the 3D objects 710, including parameters such as position, angle, tilt, yaw, roll, pitch, rotation, etc. With the placement data, the 3D engine 504 may then display the 3D objects in the 3D space 712. The 3D engine 504 is now initialized and ready to receive a first 2D image to complete virtual 3D environment.

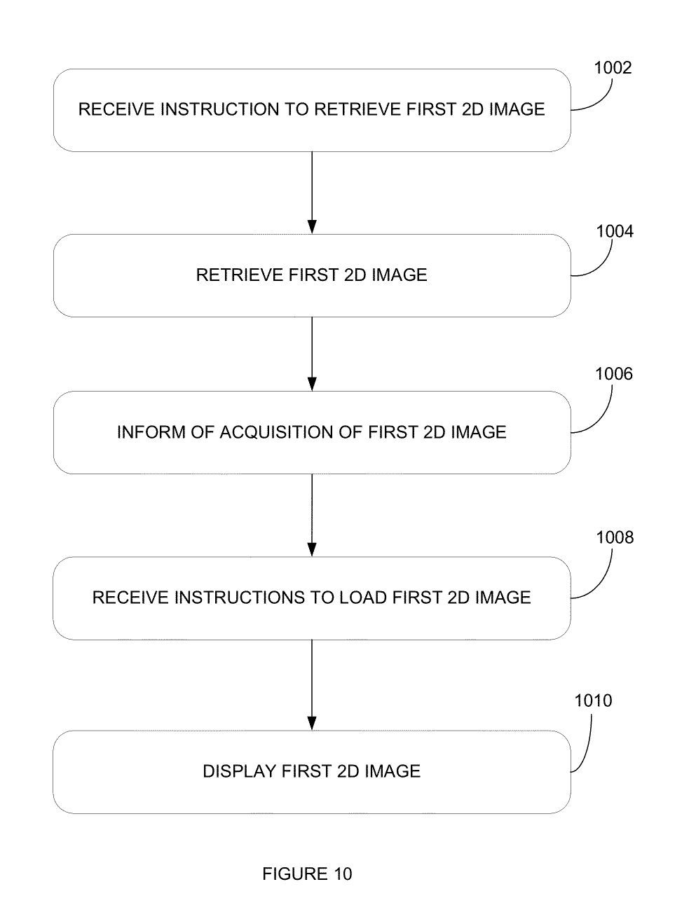

FIG. 10 is a flowchart illustrating an exemplary initialization of the photo loader 506. The photo loader 506 first receives instructions from the control center 502 to retrieve a first 2D image 1002. The first 2D image used for the 3D virtual environment may be predetermined as always being the same one, or it may be set as a function of various parameters selected by the user. For example, on a website offering a virtual visit of a house, the virtual 3D environment may be created only after the user selects which room to start the virtual visit in. The first 2D image would therefore depend on which room is selected. In this case, the instructions to retrieve the first 2D image may include specifics about which image should be retrieved. Alternatively, the photo loader 506 is simply instructed to retrieve the first 2D image as per predetermined criteria.

A first 2D image is retrieved 1004 either from a local memory or a remote memory. The photo loader 506 then informs the control center 502 that the first 2D image has been retrieved 1006. Instructions to load the first 2D image 1008 are received by the photo loader 506. The first 2D image is loaded for display 1010.

Once the first 2D image has been loaded, the camera view projection is added to the 2D image. The virtual 3D environment is ready for navigation by the user. The user may navigate through the environment using an input device such as a mouse, a keyboard or a touch screen. The commands sent through the input device will control the perspective of the image as if the user were fully immersed in the environment and moving around therein. Since the images used for the 3D environment are geo-referenced and cover about 360° of a view, the user may rotate about an axis and see the various views available from a given point. The user may also move forwards, backwards, left, right, up, down, spin left, and spin right. All of these possible moves are controlled by the user as he or she navigates through the virtual 3D environment. Table 1 is an example of a set of moves available to the user.

TABLE 1

| ID | MOVE | DESCRIPTOR | COMMENT |
|---|---|---|---|
| 1 | FORWARD | 0 | 0 DEGREES IN FIRST |
| | | | QUADRANT, X AXIS |
| 2 | RIGHT | 90 | 90 DEGREES, Y AXIS |
| 3 | BACKWARD | 180 | 180 DEGREES, X AXIS |
| 4 | LEFT | 270 | 270 DEGREES, Y AXIS |
| 5 | SPIN RIGHT | P90 | TURN RIGHT ON SAME PANO |
| 6 | SPIN LEFT | P270 | TURN LEFT ON SAME PANO |
| 7 | UP | UP | GO UP, Z AXIS |
| 8 | DOWN | DOWN | GO DOWN, Z AXIS |

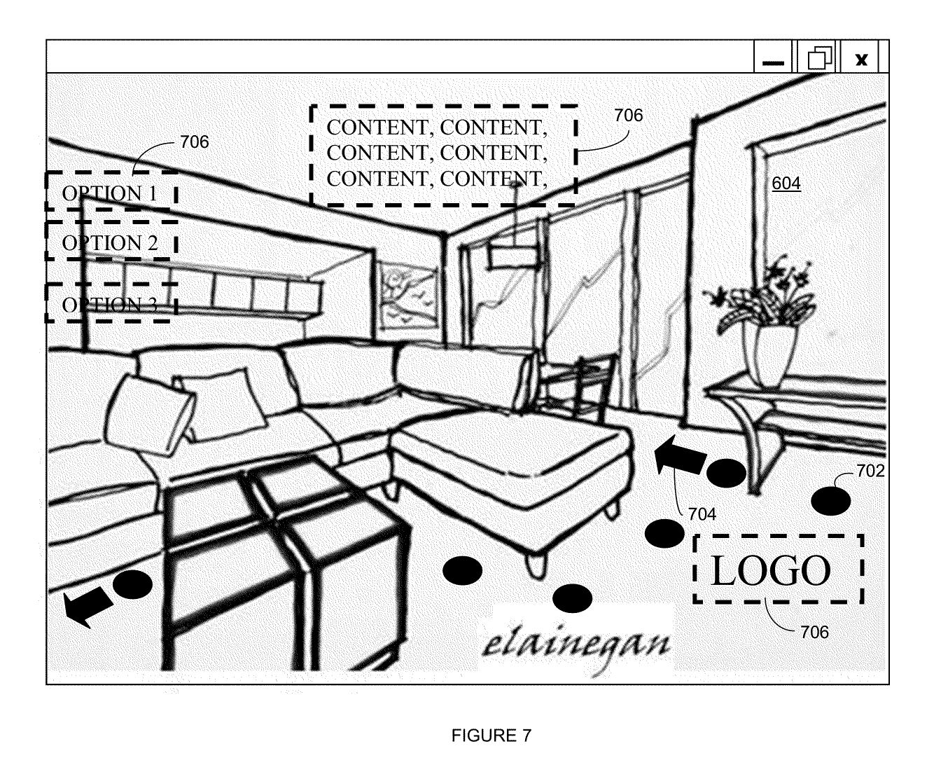

As the user moves beyond a given view and to another view including other images, the images change in a fluid manner. For example, if the user were to enter from the right side of FIG. 7 to explore the living room of the house, the view would change to a 3D virtual image of the living room from the perspective of a person standing at the given position and looking into the room. The user may navigate in this room using the various moves available to him or her. The user can move from one marker 702 to another and is cognizant of a position from which the view is shown. The user can also easily recognize the paths that may be used for the navigation with the arrows 704 adjacent to the markers. The arrows 704 show that other points of view are available for navigation if the user moves in the direction of the arrow 704.

Navigation of the user through the virtual 3D environment is managed by the control center 512. The 2D images are grouped by panorama, whereby each panorama may be referenced using a panorama ID and an (x, y, z) coordinate. Various attributes of the panorama may also be used for indexing purposes. For each panorama, all 2D images corresponding to the (x, y, z) coordinate are grouped together and may be referenced using an image ID, a camera angle, and an inclination angle. Indexing of the panoramas is done with multiple structures used to identify either a given panorama or a given image. Hashing tables, look-up tables, 3D coordinates, and other tools may be used for indexing and searching.

The panoramas may be geo-referenced in 2D by ignoring the z coordinate. For example, when the panoramas of a multi-story building are geo-referenced, the stories may be placed side-by-side instead of stacked and a “jump” is required to move from one story to another. The stories may also be connected by stairs, which may be represented by a series of single-image panoramas, thereby resulting in unidirectional navigation. One series may be used for climbing up while another series may be used for climbing down. The series of single-image panoramas may also be geo-referenced in a side-by-side manner with the stories on a same 2D plane.

In one embodiment, a link between stories (or between series/sets of panoramas) may be composed of a jump from a lower story to an upwards climbing single-image panorama series, a jump from the upwards climbing single-image panorama series to the upper story, a jump from the upper story to a downwards climbing single-image panorama series, and a jump from the downwards climbing single-image panorama series to the lower story. In one embodiment, the stairs may be climbed backwards as well, therefore requiring additional jumps.

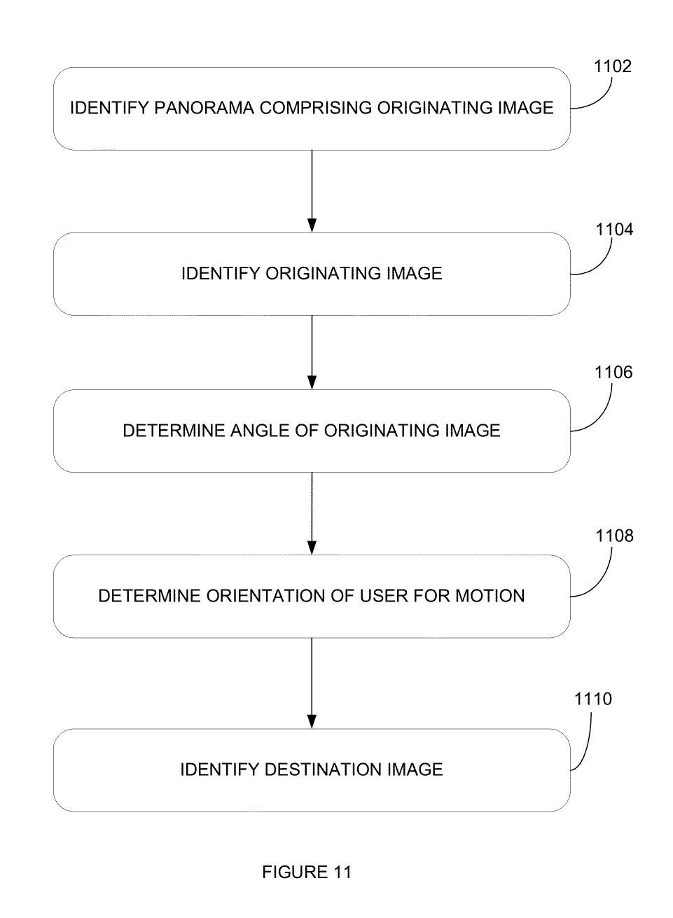

Jumps to go from an image in a first panorama series to an image in a second panorama series may be defined as links between an originating image and a destination image. An exemplary algorithm used to perform the jump from an originating image to a destination image is illustrated in FIG. 11. This algorithm is performed by the control center 502 when receiving a request to jump from an image in a first panorama to an image in a second panorama. The panorama comprising the originating image is identified 1102. The originating image itself is then identified 1104 in order to determine the angle of the originating image 1106. This angle is used to provide the destination image with a same orientation, in order to maintain fluidity. The orientation of the user for the motion (i.e. forwards, backwards, lateral right, lateral left) is determined 1108. The appropriate destination image may then be identified 1110.

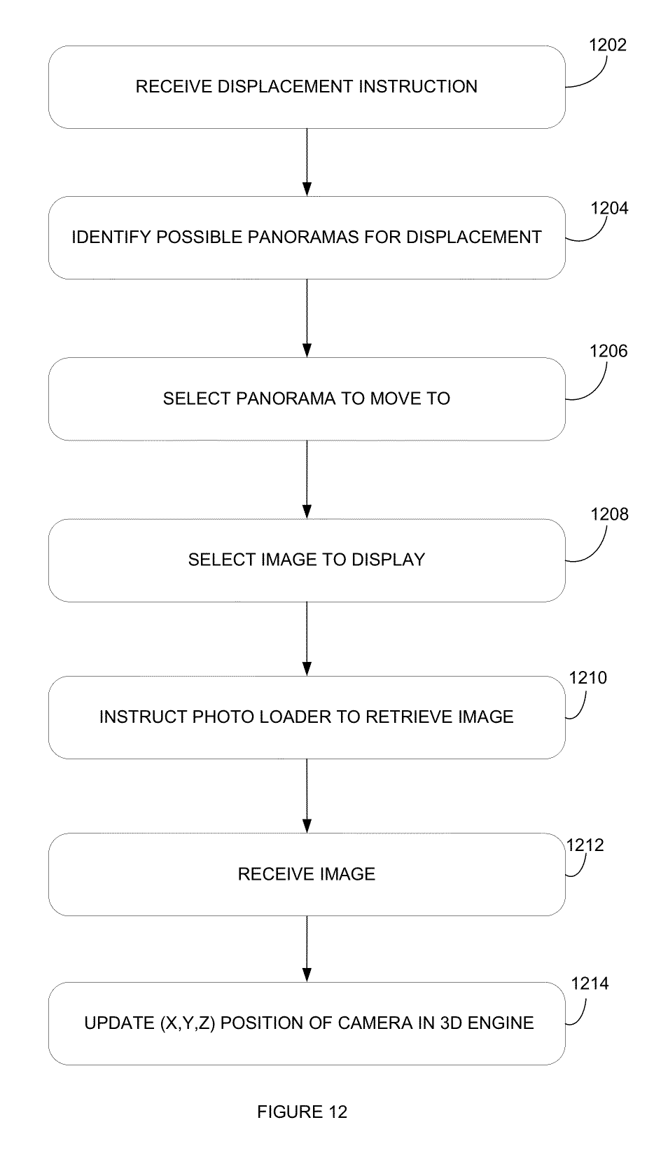

The control center 502 also manages jumping from one image to another image in a same panorama, and general navigation from panorama to panorama within a same set of panoramas. FIG. 12 is a flowchart illustrating an exemplary navigation process as performed by the control center 502 for navigating among panoramas within a same set of panoramas. When receiving displacement instructions 1202 that require displacement from one panorama to another, there may be more than one possible panorama for displacement. The control center 502 may first identify which panoramas are available for displacement 1204 and choose the one that is the most suitable 1206. When identifying possible panoramas for displacement 1204, the control center 502 is essentially looking for neighboring panoramas. This may be done by determining which panoramas are within a predetermined range of an area having a radius “r” and a center “c” at coordinate (x, y, z). The range is set by allocating boundaries along the x-axis from x+r to x−r, along the y−axis from y+r to y−r, and along the z-axis from z+r to z−r. For each whole number position along each one of the axes, the control center 502 may determine whether there exists a panorama that corresponds to the (x, y, z) coordinate.

When using the spatial arrangement illustrated in FIG. 3, the following algorithm may be followed. The variable “n” is used to represent a number of cells (i.e. panoramas) found on the x axis of the spatial representation. The variable “m” is used to represent a number of cells (i.e. panoramas) found on the y axis of the spatial representation. The variable “k” is used to represent a number of cells (i.e. panoramas) found on the z axis of the spatial representation.

nₘₐₓ=maximum number of cells on x-axis; Xₙ₊₁>Xₙ

mₘₐₓ=maximum number of cells on y-axis; Yₘ₊₁>Yₘ

kₘₐₓ=maximum number of cells on z-axis; Zₖ₊₁>Zₖ

For a vector (X, Y, Z), n is found for a smallest difference of Xₙ−X for a distance from (Xₙ, 0, 0) to (X, Y, Z)<r. This process is repeated for each value of n−1 to 0 and from n+1 to nₘₐₓ where the distance from (Xₙ, 0, 0) to (X, Y, Z)<r. Similarly, m is found for a smallest difference of Yₘ−Y for a distance from (Xₙ, Yₘ, 0) to (X, Y, Z)<r. This process is repeated for each value of m−1 to 0 and from m+1 to mₘₐₓ where the distance from (Xₙ, Yₘ, 0) to (X, Y, Z)<r. Then, k is found for a smallest difference of Zₖ−Z for a distance from (Xₙ, Yₘ, Zₖ) to (X, Y, Z)<r. This process is repeated for each value of k−1 to 0 and k+1 to kₘₐₓ where the distance from (Xₙ, Yₘ, Zₖ) to (X, Y, Z)<r. Neighboring panoramas are therefore found at (Xₑ, Yₘ, Zₖ)<r.

When choosing the panorama that is most suitable to move to 1206, this may be done by considering distances and angles between adjacent panoramas. For example, the control center 502 may choose to favor a smallest angle between adjacent panoramas while considering distance as a secondary factor. Alternatively, both angle and distance may be considered equally. Also alternatively, each one of angle and distance is given a weighting that vary as a function of its value. Other techniques for choosing a panorama may be applied.

From the selected panorama, an image is also selected 1208. Both the image and the panorama may be selected as a function of the particular command received from the user. For example, if the command received is “forward”, the viewing angle may be the same as the viewing angle of the previous image. If the command is “backward”, the viewing angle may be the inverse of the viewing angle of the previous image. If the command is “right”, the viewing angle may be the viewing angle of the previous image plus 90°. If the command is “left”, the viewing angle may be the viewing angle of the previous image minus 90°. It may also be possible to move among panoramas along the z-axis with the commands “up” and “down”. Once the desired viewing angle is determined, a minimal range of acceptable angles for a destination image may be predetermined or calculated and used for the selection process.

After selection of an image for display 1208, the photo loader 506 is instructed to retrieve the image 1210, the image is received 1212 from the photo loader 506, and the new image is loaded. A new set of coordinates for the camera corresponding to the new panorama is sent to the 3D engine 504, with accompanying parameters for angle and tilt of the camera.

It should be understood that the navigation process illustrated in FIG. 12 is applicable to displacement instructions received by keyboard from the user. If the user selects a marker using a mouse or a touch screen, steps 1204 and 1206 are no longer required as the panorama for displacement has been positively identified by the user. While coordinates (x, y, z) of the new panorama are known, an image still needs to be selected from the image set of the panorama 1208. This may be done using the coordinates of the originating panorama, the viewing angle (or image) previously displayed, and the command received from the user, as per above.

If the command received from the user corresponds to an action that does not require displacement from one panorama to another but instead only changes the viewing angle, steps 1204 and 1206 are not required as the (x, y, z) coordinate stays the same. In this case, the image to be displayed is selected 1208 as a function of the particular command received from the user. For example, if the command is “left rotation” or “right rotation”, an image having an angle greater than or less than the angle of the present image is selected. The increment used for a rotation may be the next available image or it may be a predetermined angle, such as 90°, less than or greater than the present angle, as appropriate.

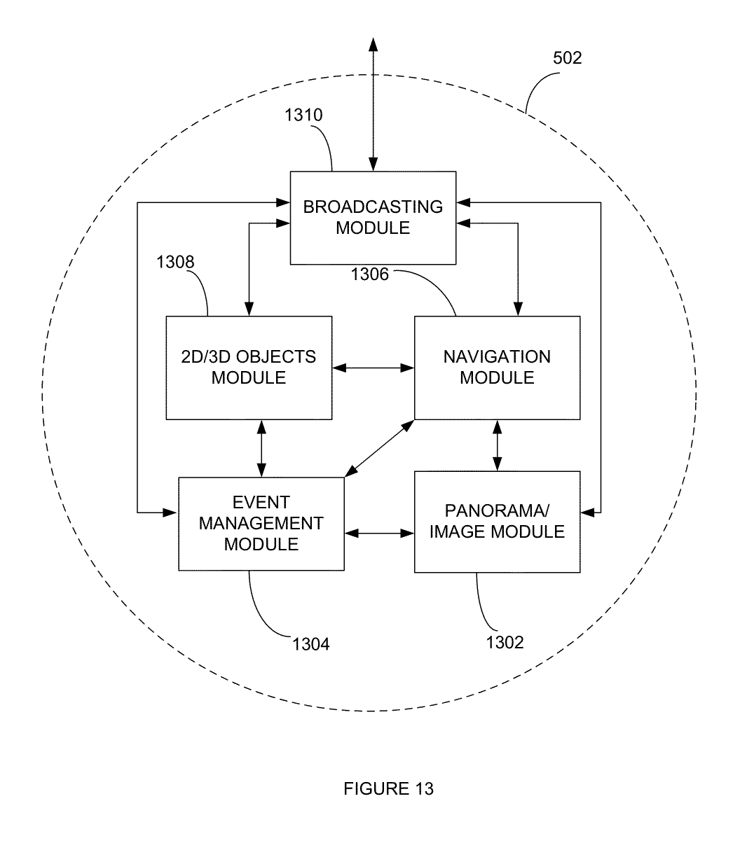

The navigation process is performed in real time by the control center 502. FIG. 13 is an exemplary embodiment of the control center. As all communications amongst the software components 512 pass through the control center 502, a broadcasting module 1320 is used to broadcast information to all software components 512 simultaneously. The information may or may not be relevant to a given software component 512. In the case of irrelevant information, the software component 512 may simply ignore the message. In the case of relevant information, the software component 512 will take appropriate action upon receipt of the message.

A navigation module may be used to perform some of the steps illustrated in FIGS. 11 and 12. In particular, the navigation module may communicate with a panorama/image module 1302 once a selection of a panorama and/or image has been made and request that the appropriate image be retrieved. The panorama/image module may manage loading the various 2D images.

An event management module 1304 may be used to manage any command received from the user. Commands may be related to displacements or changes in viewing angle, as indicated above, or to other events having associated actions. The 2D/3D objects in the virtual 3D environment may be used in a variety of ways to engage the user during the navigation. For example, the arrows 704 are set to glow whenever a mouse is positioned over the arrow 704, even only momentarily. The action of having the arrow 704 glow must be triggered once the event of “mouse coordinate=arrow coordinate” occurs. Similarly, the event of “mouse coordinate≠mouse coordinate” following the event of “mouse coordinate=arrow coordinate” will cause the arrow to stop glowing. The event management module 1304 may therefore advise a 2D/3D objects module of the event such that the action can be triggered.

In another example, a given event such as a mouse click or a mouse coordinate will result in anyone of the following actions: load a new virtual 3D environment, jump to an image, open a web page, play a video, provide a pop-up HTML. Therefore, the event management module 1304, upon receipt of any event, may determine if an action is associated with the event and if so execute the action. Execution of the action may include dispatching an instruction to anyone of the other modules present in the control center 502, such as the panorama/image module 1302, the navigation module 1306, the 2D/3D objects module 1308, and any other module provided to manage a given aspect or feature of the virtual 3D environment.

In one embodiment, gaming features may also be incorporated into the virtual 3D environment using the 2D/3D objects. For example, a user may be provided with points or prizes when navigating certain images, when performing certain tasks and/or when demonstrating certain behaviors. The gaming features may be triggered by various events, such as purchasing an item, selecting an item, navigating in the 3D environment, collecting various items during navigation, etc. Virtual “hotspots”, i.e. locations that have actions associated thereto, are created with the 2D/3D objects and incorporated into the navigation. The control center 502 manages the navigation and gaming elements while the 3D engine 504 manages the 3D space.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, a computer readable medium or an electrical or electro-magnetic signal. The embodiments of the invention described above are intended to be exemplary only. The scope of the invention is therefore intended to be limited solely by the scope of the appended claims.

1. An apparatus for providing a virtual 3D environment comprising:
a storage medium for storing at least one 3D object and at least one 2D image from a plurality of sets of 2D images, each set of 2D images corresponding to a substantially 360° view at a given position in a 3D space, each 2D image in the set of 2D images corresponding to a view at a viewing angle at the given position in the 3D space;
a 3D engine for creating the 3D space and displaying the at least one 3D object in the 3D space; and
a control center connected to the storage medium and the 3D engine and adapted for:
loading a 2D image from a selected one of the plurality of sets of 2D images and projecting a camera view of the 3D engine onto the 2D image such that the 2D image and the at least one 3D object are blended together to form an initial view in the virtual 3D environment;
receiving navigation instructions;
determining in real time a new 2D image corresponding to a desired viewing position and a desired viewing angle in accordance with the navigation instructions;
determining if the at least one 3D object requires modification and instructing the 3D engine accordingly; and
loading the new 2D image such that the new 2D image and the at least one 3D object are blended together to form a subsequent view in the virtual 3D environment.

2. The apparatus of claim 1, wherein the control center is adapted for projecting the camera view of the 3D engine onto the 2D image such that the 2D image is displayed on a 2D plane outside of the 3D engine and the at least one 3D object is projected onto the 2D plane.

3. The apparatus of claim 2, wherein the camera view of the 3D engine projected by the control center contains the at least one 3D object and the selected set of 2D images from which the control center loads the 2D image contains a background of the virtual 3D environment.

4. The apparatus of claim 3, wherein the control center is adapted for projecting the camera view of the 3D engine onto the 2D image such that the at least one 3D object is overlaid onto the background.

5. The apparatus of claim 1, wherein determining in real time a new 2D image comprises searching the storage medium for the new 2D image within ones of the plurality of sets of 2D images neighboring the selected set of 2D images.

6. The apparatus of claim 1, wherein the storage medium stores each one of the plurality of sets of 2D images according to an optimized spatial representation.

7. The apparatus of claim 7, wherein the storage medium sorts the 2D images in each set of 2D images according to an x axis value, a y axis value, and a z axis value corresponding to a discrete position of each one of the 2D images in the 3D space.

8. The apparatus of claim 8, wherein the storage medium arranges the 2D images in each set of 2D images such that no empty discrete positions are provided between successive ones of the 2D images.

9. The apparatus of claim 1, wherein the control center comprises an event management module adapted for receiving commands from a user, identifying an action associated with the command, and triggering the action.

10. The apparatus of claim 9, wherein triggering the action comprises instructing the 3D engine that the at least one 3D object requires modification.

11. The apparatus of claim 9, wherein triggering the action comprises loading a new set from the plurality of sets of 2D images.

12. A method for providing a virtual 3D environment, the method comprising:
storing a plurality of 3D objects and a plurality of sets of 2D images, each set of 2D images corresponding to a substantially 360° view at a given position in a 3D space, each 2D image in the set of 2D images corresponding to a view at a viewing angle at the given position in the 3D space;
creating the 3D space with a 3D engine and displaying the 3D objects in the 3D space;
loading a 2D image from a selected one of the plurality of sets of 2D images and projecting a camera view of the 3D engine onto the 2D image such that the 2D image and the 3D objects are blended together to form an initial view in the virtual 3D environment;
receiving navigation instructions;
determining in real time a new 2D image corresponding to a desired viewing position and a desired viewing angle in accordance with the navigation instructions;
determining if the 3D objects require modification and instructing the 3D engine accordingly; and
loading the new 2D image such that the new 2D image and the 3D objects are blended together to form a subsequent view in the virtual 3D environment.

13. The method of claim 12, projecting the camera view of the 3D engine onto the 2D image comprises displaying the 2D image on a 2D plane outside of the 3D engine and projecting the 3D objects onto the 2D plane.

14. The method of claim 13, wherein projecting the camera view of the 3D engine onto the 2D image comprises projecting the camera view containing the 3D objects onto the 2D image containing a background of the virtual 3D environment for overlaying the 3D objects onto the background.

15. The method of claim 11, wherein determining in real time a new 2D image comprises searching for the new 2D image within ones of the plurality of sets of 2D images neighboring the selected set of 2D images.

16. The method of claim 11, wherein storing the plurality of sets of 2D images comprises storing each one of the plurality of sets of 2D images according to an optimized spatial representation.

17. The method of claim 16, wherein storing the plurality of sets of 2D images comprises sorting the 2D images in each set of 2D images according to an x axis value, a y axis value, and a z axis value corresponding to a discrete position of each one of the 2D images in the 3D space.

18. The apparatus of claim 17, wherein storing the plurality of sets of 2D images comprises arranging the 2D images in each set of 2D images such that no empty discrete positions are provided between successive ones of the 2D images.

19. A computer readable medium having stored thereon computer executable code for providing a virtual 3D environment, the computer executable code comprising instructions for:
accessing a storage medium comprising a plurality of 3D objects and at least one 2D image from a plurality of sets of 2D images, each set of 2D images corresponding to a substantially 360° view at a given position in a 3D space, each 2D image in the set of 2D images corresponding to a view at a viewing angle at the given position in the 3D space;
creating the 3D space with a 3D engine and displaying the 3D objects in the 3D space;
loading a 2D image and projecting a camera view of the 3D engine onto the 2D image such that the 2D image and the 3D objects are blended together to form an initial view in the virtual 3D environment;
receiving navigation instructions;
determining in real time a new 2D image corresponding to a desired viewing position and a desired viewing angle in accordance with the navigation instructions;
determining if the 3D objects require modification and instructing the 3D engine accordingly; and
loading the new 2D image such that the new 2D image and the 3D objects are blended together to form a subsequent view in the virtual 3D environment.
